(19) United States
(12) Patent Application Publication
(10) Pub. No.: US 2025/0135555 A1
(43) Pub. Date: May 1, 2025

(54) TOOLHOLDER AND TOOLHOLDER SYSTEM COMPRISING THE SAME

(71) Applicant: C. & E. Fein GmbH, Schwaebisch Gmuend (DE)

(72) Inventors: Sergei DENZEL, Schwaebisch-Gmuend (DE); Stefan SCHERRENBACHER, Waldstetten (DE)

(73) Assignee: C. & E. Fein GmbH, Schwaebisch Gmuend (DE)

(21) Appl. No.: 18/929,028

(22) Filed: Oct. 28, 2024

(30) Foreign Application Priority Data
Oct. 26, 2023 (EP) 23 206 182.08

(51) Int. Cl. B23B 29/04; B23B 31/10

(52) U.S. Cl. CPC B23B 29/04; B23B 31/101

(57) ABSTRACT

A toolholder for a tool having a flat surface that can be rotated about an axis of rotation, in particular, a Weldon toolholder for a milling tool or a core drill. A clamping jaw has a contact surface spaced from the flat surface side of the flat surface and touches the flat surface when the clamping jaw is pressed against the flat surface in a second arrangement of the clamping jaw or in the assembly position of the tool. A stationary machine tool comprising this toolholder and a tool and a method for manufacturing thereof are also provided.

This nonprovisional application claims priority under 35 U.S.C. § 119 (a) to European Patent Application No. 23 206 182.08, which was filed on Oct. 26, 2023, and which is herein incorporated by reference.

### BACKGROUND OF THE INVENTION

### Field of the Invention

The present invention relates to a toolholder and a toolholder system, a stationary machine tool, which comprises this toolholder, and a method for manufacturing the toolholder.

### Description of the Background Art

In the conventional art, toolholders are known for a tool of various types that can be rotated about an axis of rotation. In particular, the Weldon toolholder is suitable for holding tools such as a milling tool or a drill, especially core drills when used in particular as part of an electrical drill, a stationary milling machine or a core drilling machine.

In the Weldon toolholder, one or two flat surfaces are molded to the cylindrical shank of a tool, at a distance from the end of the shank. A holder designed in this way is fastened either by means of two hexagon socket screws that reach through the working spindle or by clamping jaws inside the working spindle.

Weldon chuck systems or Weldon toolholders are particularly tool devices that are used to securely fix tools. Characteristic of these holders is a cylindrical bore, with variants with and without coolant channels. Weldon chuck systems are used in particular to hold milling tools and drilling tools with a cylindrical shank and lateral contact surface. The cylindrical tool shanks, which are suitable for use with the Weldon toolholder and have a lateral entrainment surface, in particular flat surface (Weldon flat), can be designed in particular in accordance with the standards DIN 1835-B and DIN 6535-HB.

For example, when used in a core hole drilling machine, a tool with a Weldon toolholder is attached by means of at least one clamping jaw located within the working spindle. To this end, a deflection sleeve, for example, is axially moved downwards, wherein the spring-mounted clamping jaw is transferred radially outwards into a receptacle in an initial arrangement, thereby freeing up the cylindrical receptacle space of the working spindle. The tool can then be pushed into the working spindle up to an assembly position. The spring-mounted deflection sleeve returns to its starting position, the clamping jaw is pushed radially inwards in a second arrangement and rests against a flat surface of the tool with a clamping surface. In known Weldon toolholders, the area in which the clamping surface of the clamping jaw is in contact with the flat surface of the Weldon toolholder of the tool extends to the transition area of the flat contact surface to the cylindrical outer surface of the tool shank. This means that the tool is securely locked in the working spindle.

The outer diameter of the cylindrical shank of the tool and the inner diameter of the receiving sleeve of the working spindle, in particular the outer radius r1 and the receiving radius R1 differ only slightly, so that play-free insertion is possible. However, r1<R1 always applies. The deviation in a few hundredths or thousandths of a millimeter is in particular between 0.09 and 0.001 mm.

Under extreme working conditions, especially in the operation of core hole drilling machines, an axial accumulation of material or a material throw-up occurs in the area of the transition of the flat contact surface (flat surface) into the cylindrical part of the tool shank. The associated increase in the diameter of the maximum diameter of the tool shank beyond the inner radius of the receiving sleeve leads to the tool no longer being able to be removed from the working spindle or only to be removed with difficulty due to the accumulation of material that exceeds the inner radius.

### SUMMARY OF THE INVENTION

It is therefore an object of the present invention to solve this extraction problem.

In an example, the clamping surface of the clamping jaw is designed in such a way that, in the second arrangement, it touches the flat surface of the tool shank only at points of the flat surface that are protected by the side of the flat surface, which is located in particular in the direction of rotation. This flat surface side of the flat surface, which is located in particular in the direction of rotation, marks or forms the transition area of the flat surface to the cylindrical outer surface of the tool shank.

In order to achieve this, according to an example, the clamping jaw can have at least one recess, in particular axially running in the clamping surface, which in the second arrangement of the clamping jaw is opposite the flat surface. In particular, the position of the recess is such that its radial distance from the axis of rotation is less than the radial distance of the outer radius r1 from the axis of rotation and/or is smaller than the receiving radius R1 and/or is smaller than the radial distance of the flat surface side from the axis of rotation. Consequently, the contact area between the clamping jaw and the flat surface is shifted inwards away from the flat surface side along the flat surface. As a result, the material accumulation occurs at another point on the tool shank, namely along the flat surface inwards, away from the edge of the above-mentioned transition of the flat surface thus located on the hollow-cylindrical receiving surface of the working spindle. Due to the fact that the location of the material accumulation is spaced from the receiving surface of the working spindle, the material accumulation has no influence on the tool removal. It is particularly preferable that, in the second arrangement of the clamping jaw, the position of the recess on the clamping surface corresponds to the position of the transition of the flat surface into the cylindrical section of the tool shank, i.e., in particular the position of the flat surface side.

The toolholder is designed in particular to ensure that in the second arrangement, the flat surface side is arranged at a distance from the clamping surface. Preferably, the toolholder is designed such that in the second arrangement, an in particular strip-shaped area of the flat surface axially extending along the flat surface side is arranged at a distance from the clamping surface and does not contact the latter. This shifts the harmful accumulation of material on the flat surface radially inwards about the width of the strip-shaped area and allows for the tool to be removed. In practice, the clamping surface contour is shifted radially inwards from the flat surface side by a distance “s” in such a way that the distance s is just sufficient to shift the accumulation of material arising under load radially inwards in order to avoid the extraction problem, but not in such a way that the distance s is unnecessarily large. Ultimately, the contact between the clamping surface and the flat surface serves to transmit the torque, so that the contact surface/contact area should in principle be kept as large as possible.

The distance s by which the clamping surface contour is distanced from the flat surface side is preferably selected from one of the following preferred ranges: 0.1 mm to 5.0 mm; 0.1 mm to 4.0 mm; 0.1 mm to 3.0 mm; 0.1 mm to 2.0 mm; 0.1 mm to 1.0 mm; wherein the lower limit may also be: 0.2 mm or 0.3 mm or 0.4 mm or 0.5 mm, or 0.6 to 0.9 mm.

In particular, the flat surface side is a straight line. This results in a preffered example of the toolholder because the flat surface is a rectangular base surface running parallel to the axis of rotation of a recess of a cylindrical tool shank. However, the flat surface side may also deviate from the shape of the line, in particular in sections.

The flat surface can be a rectangle, but it can also have curved outer contours, especially if the flat surface is inclined in relation to the axis of rotation. This is optionally provided, for example, within the framework of the industry standards defining the Weldon toolholder.

In the second arrangement, the portion of the clamping surface that touches the flat surface is called the contact surface. This has a clamping surface contour, which is in particular an outer side of the clamping surface. In the second arrangement, the clamping surface contour is spaced from the flat surface side, in particular by the section s. The clamping surface contour can be a continuous or interrupted straight or odd line; the decisive factor is that the accumulation of material resulting in practice makes it possible to remove the tools. Preferably, the clamping surface contour is a continuous straight line corresponding to one side of a rectangular clamping surface.

In the second arrangement, the clamping surface contour is in particular closer to the axis of rotation than the hollow cylindrical inner surface of the working spindle surrounding the receiving space. In the second arrangement, the minimum distance m of the clamping surface contour from the axis of rotation is less than the receiving radius R1.

In the second arrangement, the clamping surface contour is in particular closer to the rotation axis than the cylindrical outer surface r1 of the tool shank. The minimum distance m of the clamping surface contour from the axis of rotation in the second arrangement is smaller than the outer radius r1 of the tool shank.

In the second arrangement, the clamping surface contour is particularly closer to the axis of rotation than the flat surface side. The minimum distance m of the clamping surface contour from the axis of rotation in the second arrangement is smaller than the minimum distance of the flat surface side from the rotation axis.

In particular, due to the features mentioned in the three preceding paragraphs, the clamping surface does not touch the flat surface side in the second arrangement of the clamping jaw. Preferably, the clamping surface in the second arrangement of the clamping jaw does not touch an area adjacent to the flat surface side, in particular not a strip-shaped area of the flat surface that runs axially up to the distance s from the flat surface side. This avoids an accumulation of material in the flat surface in the area near the flat surface side.

In an example, the clamping jaw can have at least one recess, in particular axially extending in the flat clamping surface. In particular, the transition from the flat clamping surface to the recess is formed or marked by the clamping surface contour.

In particular, the recess can be an indentation of the clamping surface, which can be inserted into the clamping surface, in particular by milling. In particular, the indentation has an opening located in the clamping surface. The opening has a particularly axial and particularly strip-shaped opening cross-section, which lies in the plane of the clamping surface. Preferably, a position of the recess in the clamping surface, in particular a position in the opening cross-section of the recess, in the second arrangement is such that: a radial distance of the position from the axis of rotation corresponds to the inner radius R1 of the toolholder, and/or a radial distance of the position from the axis of rotation corresponds to the outer radius r1 of the tool shank, and/or a radial distance of the position from the axis of rotation is greater than the radial distance m of the clamping surface contour from the axis of rotation.

Since the clamping surface in the area of the opening cross-section of the recess does not touch the flat surface of the tool shank in the second arrangement, there is also no undesirable accumulation of material in this recessed area on the flat surface.

In particular, the clamping surface contour forms an axial outer side of the clamping surface. This applies in the event that the clamping surface has an axial recess. However, it also applies if the clamping surface has no recess and, in particular, is smaller than the flat surface.

The clamping surface can have a contact surface, and the toolholder is preferably designed such that the contact surface in the second arrangement contacts the flat surface, in particular its contact area. In particular, only those surface areas of the clamping surface are referred to as contact surfaces, which in the second arrangement touch the flat surface, wherein in particular the contact surface is smaller than the flat surface.

Similarly, in particular, only those areas of the plan surface are referred to as contact areas which are touched by the clamping surface, in particular its contact surface, in the second arrangement.

The flat surface can be rectangular. In particular, the flat surface has a second flat surface side opposite the first flat surface side, which in particular both run axially and thus parallel. The distance between the first flat surface side and the second flat surface side corresponds to the width B of the flat surface.

The toolholder can be designed such that, in the second arrangement, the first flat surface side does not touch the clamping surface and, in particular, the second front surface side touches the clamping surface. However, it is also possible and preferable that in the second arrangement, the second flat surface side does not touch the clamping surface. In the latter case, the contact area is completely spaced from the axial flat surface sides.

In particular, the contact area can be smaller than the flat surface.

The clamping surface can have more than one recess.

The clamping surface can have no recess. In this case in particular, the flat surface in the second arrangement preferably, at least on one axial side of the clamping surface, extends beyond the clamping surface and the clamping surface contour, in particular, is adjacent to the flat surface at a distance from the flat surface side.

The invention also relates to a stationary machine tool, in particular a drilling machine, a milling machine or a core drilling machine which has a toolholder according to the invention.

The invention also relates to a toolholder system for a tool that can be rotated about an axis of rotation, wherein the toolholder system has a toolholder, in particular according to the invention, and the tool with the tool shank, wherein the toolholder has a working spindle that extends along the axis of rotation (A) and which has an axial cylindrical receiving space comprising a receiving radius (R1), into which the tool shank, which is cylindrical at least in sections and has an outer radius (r1), can be inserted into an assembly position of the tool shank by axially moving the tool shank, wherein the tool shank has at least one flat surface radially shifted inwards from the outer radius (r1), which has an axial flat surface side forming a transition of the flat surface to the cylinder surface of the tool shank, wherein the toolholder has at least one radially movable clamping jaw with a flat clamping surface, wherein the toolholder is designed such that, in a first arrangement of the clamping jaw, the minimum distance (a1) of the clamping surface from the axis of rotation (A) is greater than or equal to the outer radius (r1) of the tool shank, and in a second arrangement of the clamping jaw, the minimum distance (a2) of the clamping surface from the axis of rotation (A) is less than the outer radius (r1) of the tool shank, and the clamping surface in the assembly position contacts a contact area of the flat surface and the contact area is spaced from the flat surface side.

The invention also relates to a method for producing the toolholder, comprising the step of the shape of the clamping surface of at least one clamping jaw being formed in such a way that the clamping surface in the assembly position contacts a contact area of the flat surface and the contact area is spaced from its flat surface side, in particular that the at least one clamping jaw is formed in such a way that the clamping surface contour in the second arrangement contacts the flat surface and is spaced from its flat surface side. In particular, this shaping can be carried out in such a way that the axial recess is provided in the flat clamping surface, which can be done in particular by means of a material-removing process, such as milling.

The toolholder can have a coupling section, which is connected in particular to the working spindle and via which the working spindle can be coupled to the drive shaft of a drive device, in particular an electric motor, a stationary tool machine. In particular, the coupling section may be a gear element, in particular a gear wheel, of a gearbox by means of which the working spindle is driven.

The toolholder can have an axially movable clamping sleeve, which is arranged in particular around the working spindle. The clamping sleeve is axially movable on the working spindle and is spring-loaded in particular against the axial deflection.

The at least one clamping jaw is, in particular, arranged to be radially movable on the working spindle, so that the clamping jaw of at least one force-forming or form-forming part, such as a spring, is pushed radially outwards in particular to move from the second arrangement to the first arrangement.

The clamping sleeve can be shaped in such a way that the at least one clamping jaw can get into a radially deflected position when the clamping jaw is moved from the second arrangement to the first arrangement. The clamping sleeve is preferably shaped in such a way that the at least one clamping jaw is forcibly pushed inwards radially from an inner surface of the clamping sleeve when the clamping jaw is moved from the first arrangement to the second arrangement. In particular, the clamping sleeve has at least one radial recess in the inner surface of the clamping sleeve surrounding the tool shank, into which a clamping jaw engages in its first arrangement or into which the clamping jaw retracts when the clamping sleeve is axially deflected and the clamping jaw moves from the second arrangement to the first arrangement.

The toolholder can have an axially acting spring bearing, consisting of a spring element and an axially movable centering pin. As a result, after successfully drilling a borehole, the core of the hole, which is located within a cavity of the tool, can be pushed out of the tool.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a side view of an exemplary stationary tool machine according to the invention, which has a toolholder according to an example of the invention.

FIG. 1b shows a side view of a working unit of an exemplary inventive stationary machine tool, which comprises a toolholder according to an example of the invention.

FIG. 1c shows a side view of the working unit from FIG. 1b, without housing parts.

FIG. 2 shows a side view of a toolholder system according to an example of the invention, which has a toolholder according to an example of the invention and a tool.

FIG. 3 shows a cross-section of the toolholder of FIG. 1b, in the x-z plane.

FIG. 4a schematically shows a cross-section of the toolholder of FIG. 1b, along the x-y plane at the level of the clamping jaw in its first arrangement, with the tool shank inserted.

FIG. 4b schematically shows a cross-section of the toolholder of FIG. 1b, along the x-y plane at the level of the clamping jaw in its second arrangement, with the tool shank in the assembly position.

FIG. 4c shows a detail of FIG. 4b.

FIGS. 4d and 4e show a perspective view of the clamping jaw of the toolholder of FIG. 1b,

FIG. 4f shows a cross-section of the toolholder of FIG. 1b, along the x-y plane at the level of the clamping jaw.

FIG. 5a schematically shows a cross-section of a toolholder not according to the invention, along the x-y plane at the level of the clamping jaw in its second arrangement, with the tool shank in the assembly position.

FIG. 5b schematically shows a cross-section of the toolholder of FIG. 1b, along the x-y plane at the level of the clamping jaw in its second arrangement, with the tool shank in the assembly position.

FIG. 5c schematically shows a cross-section of a toolholder in accordance with an example of the invention, along the x-y plane at the level of the clamping jaw in its second arrangement, with the tool shank in the assembly position.

FIG. 6a shows the flat surface of the tool shank from FIG. 5a.

FIG. 6b shows the flat surface of the tool shank from FIG. 5b.

FIG. 6c shows the flat surface of the tool shank from FIG. 5c.

FIG. 7 shows three views of a cross section of the toolholder of FIG. 1b, in

the x-z plane, with in each case different positions of the clamping sleeve and the clamping jaw.

### DETAILED DESCRIPTION

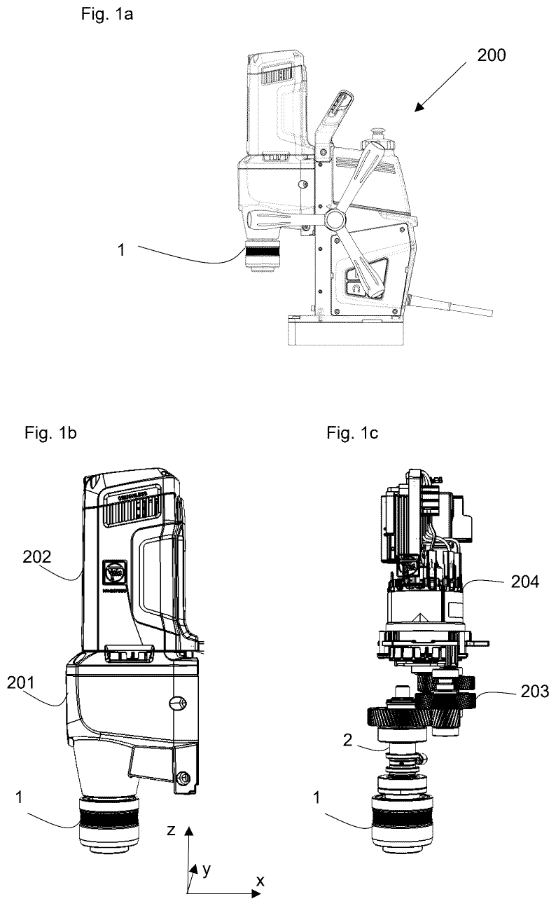

FIG. 1a shows a stationary tool machine 200, here a core drilling machine which has a toolholder 1.

FIG. 1b shows a working unit of the core drilling machine 200, which has a toolholder 1. The working unit has a motor housing 202 and a gearbox housing 201.

FIG. 1c shows the electric motor 204 arranged in the motor housing 202 as the drive unit, the gearbox 203 arranged in the gearbox housing 201 and the working spindle 2 of the toolholder 1 driven by the gearbox.

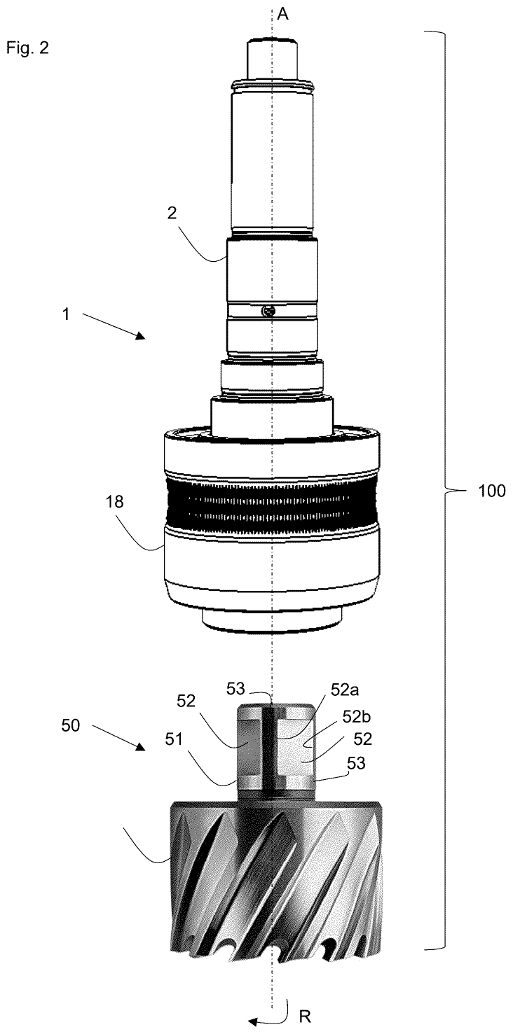

FIG. 2 shows the toolholder system 100, which has the toolholder 1 and a tool 50, which is a core milling cutter with a tool shank 51 and a Weldon toolholder.

As shown in FIG. 2, the toolholder 1 is used to hold a tool 50 which can be rotated in the direction of rotation R about an axis of rotation A, which here has a Weldon toolholder. The rotation transmits torque from the working spindle to the tool shank under load.

The tool shank 51 of the tool 50 is designed to fit the toolholder 1, and has two flat surfaces 52, each of which is bounded by an axially running first flat surface side 52a and an axially running second flat surface side 52b of the flat surface, which each mark or form the transition from the outside of the tool shank 51 to the cylindrical section 53 of the tool shank 51.

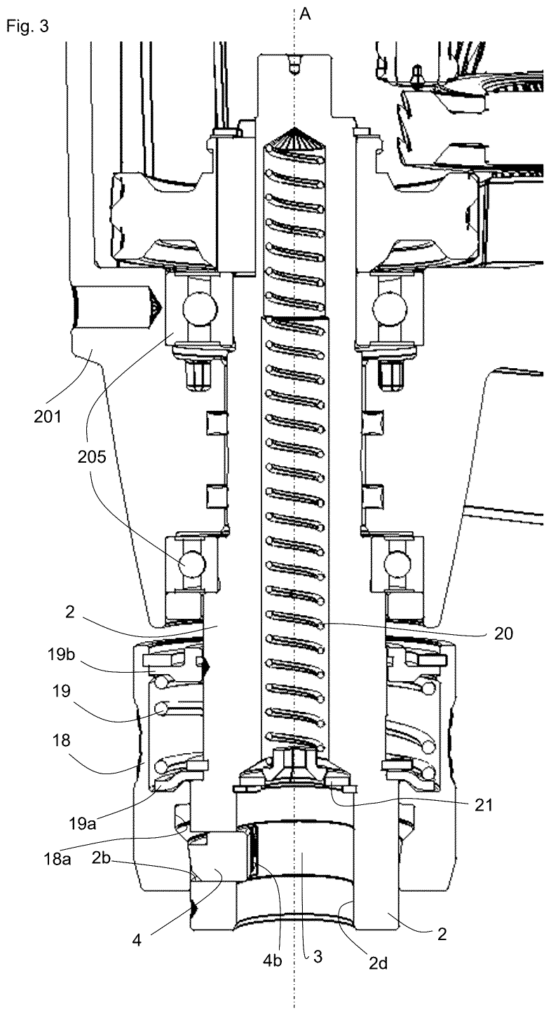

FIG. 3 shows a cross-section of the toolholder 1 from FIG. 1b, in the x-z plane. The working spindle 2 is arranged on the gearbox housing 201 so as to be rotated via two ball bearings 205 about the axis A. At the lower end of the working spindle, a hollow cylindrical receiving space 3 of the working spindle is shown, into which the essentially cylindrical tool shank 51 of a tool 50 is inserted from below when the clamping jaw 4 is in its first arrangement. (FIG. 3 shows the position of the clamping jaw 4 in its second arrangement, where the clamping jaw engages in the receiving space 3, so that the insertion of the tool is not possible.) An inserted tool shank 51 rests with its outer surface 53 almost free of play against the cylindrical inner surface 2d of the working spindle, which surrounds the receiving space 3 (not shown).

The clamping jaw 4 can be moved radially and is essentially mounted backlash-free in the recess 2b of the working spindle 2. The clamping jaw 4 is continuously pressed into the receiving pocket 18a by radially acting springs (not shown in FIG. 3) when the clamping sleeve 18 is moved downwards. This will be explained on the basis of FIG. 7.

The insertion of tool 50 is made possible by manually moving the clamping sleeve 18 downwards. The tool sleeve 18 is mounted on the working spindle 2 so as to be axially movable along the z-direction. When the clamping sleeve 18 is moved axially downwards, the coil spring 19, which is located on the outside of the working spindle 2, is axially compressed. The coil spring 19 is mounted on the annular disc 19a, which is fixed to the working spindle 2. At the top, the coil spring 19 is mounted on the annular element 19b, which is fixed in the clamping sleeve. The annular element 19b has a radially, internally arranged sliding surface by means of which the clamping sleeve is radially supported on the working spindle 2 and can be moved axially on it.

The toolholder preferably has an axially acting spring bearing, consisting of a spring element and an axially movable centering pin. As a result, after a borehole has been successfully drilled, the core of the hole, which is located within the tool, can be pressed from the tool.

Above the receiving space 3 of the working spindle 2 extends a cylindrical cavity of the working spindle 2, in which a spring bearing, a compressible coil spring 20 and a centering pin (not shown) are arranged. After successfully drilling a core hole, the core of the hole, which may be located within a cavity of the tool, can be ejected by activating the centering pin.

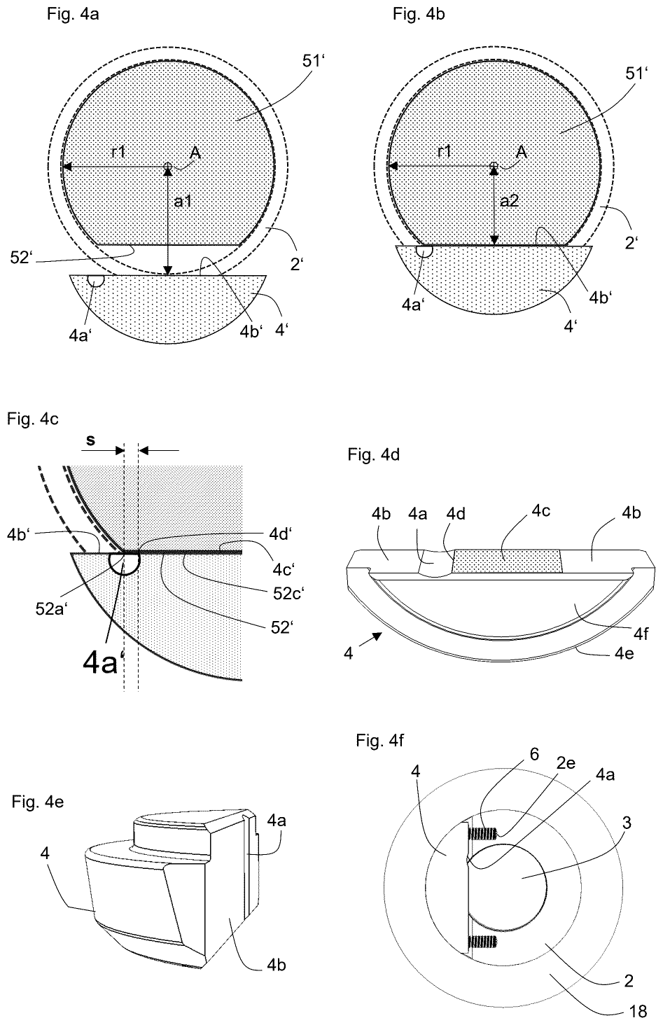

As can best be seen in FIG. 4a, the clamping surface 4b′ in the first arrangement of the clamping jaw 4′ shown in FIG. 4a is arranged at a distance a1 from the axis of rotation A, wherein the distance a1 is greater than or equal to the outer radius r1 of the tool shank 51′. This frees up the receiving space 3 and the tool 50 can be inserted into the receiving space 3 of the working spindle 2′ by axial movement. FIG. 4a shows the inserted position of the tool shank 51′, in which the clamping surface 4b′ of the clamping jaw 4′ is opposite the flat surface 52′ of the tool shank 51′ in the radial direction.

In FIG. 4b, the tool 50 is mounted in the toolholder, the tool shank 51′ is in the assembly position. The clamping jaw 4′ is located in the second arrangement in which the clamping surface 4b′ contacts the flat surface 52′ of the tool shank 51′. This allows for the torque of the motor to be transferred to the tool shank 51′ by means of the clamping jaw 4′. The clamping surface 4b′ is located at a radially measured distance a2 from the axis of rotation A, wherein the distance a2 is smaller than the outer radius r1 of the tool shank 51′ and less than the distance a1.

As can be seen in FIG. 4c, the clamping surface 4b′ has a recess 4a′. In the second arrangement, the recess 4a′, here an axial groove, is opposite the flat surface 52′ such that the flat surface side 52a′ does not contact the clamping surface 4b′. The clamping surface 4b′ is only contacted by the flat surface 52′ in its contact area 4c′. Accordingly, the contact area 52c′ of the flat surface 52′, which is contacted by the clamping surface 4b′, is spaced by a distance s from the flat surface side 52a′ of the flat surface 52′. The contact surface 4c′ has an outer surface formed by a straight, axial clamping surface contour 4d′. The clamping surface contour 4d′, and with it the contact surface 4c′, are spaced from the flat surface side 52a′ by the distance s. Only those surface areas of the clamping surface 4b′ are referred to as contact surfaces 4c′ which touch the flat surface 52′ in the second arrangement. In particular, the contact surface 4c′ is smaller than the flat surface 52′. The contact surface 4c′ and the contact area 52c′ are the same size.

The distance s, measured perpendicular to the axis A and along the flat surface 52′, is about 3 mm in this case. Due to the distance of the contact area 52c′ from the flat surface side 52a′ of the flat surface, there is no load on the flat surface in the area between the flat surface side 52a′ and the clamping surface contour 4d′ when a torque is transmitted from the working spindle 2′ to the tool shank 51′ by means of the clamping jaw 4′.

The width of the recess 4a′, measured in the direction perpendicular to the axis A in the plane of the clamping surface 4b′, is 3.0 mm in this case. The maximum depth of the recess 4a′, measured in the direction perpendicular to the clamping surface, is 0.5 mm. The total width of the clamping surface 4b′ or the clamping jaw 4′, measured perpendicular to the axis A and along the flat surface 52′, is 30 mm in this case.

FIG. 4d shows the clamping jaw 4 of the toolholder 1. It is a part, which essentially has the shape of a circular disc segment. A circular outer contour 4e of the clamping jaw 4 is shaped in such a way that it can be inserted into the hollow cylindrical receiving pocket 18a, which is provided in the clamping sleeve 18. The clamping surface 4b, which runs perpendicular to the upper side 4f of the clamping jaw 4, shows the axially running groove 4a, the contact surface 4c, which in the second arrangement of the clamping jaw 4 contacts the contact area of the flat surface 52, and the clamping surface contour 4d, which forms the outside of the contact surface 4c and also the transition to the groove 4a.

FIG. 4e shows a perspective side view of the clamping jaw 4. A structural feature of the clamping jaw 4 is the beveling of the outer side(s) of the clamping jaw, which is different from the clamping surface 4b, which connects the upper and underside of the clamping jaw. These outer sides are inclined with respect to the clamping surface 4b and with respect to the horizontal. This makes it easier to insert the clamping jaw 4 into the receiving pocket 18a (FIG. 7) for the clamping jaw 4 provided on the inside of the clamping sleeve 18.

FIG. 4f shows a cross-section of the toolholder 1 in FIG. 1b, along the x-y plane at the level of the clamping jaw 4 in its second arrangement. Shown here are coil springs 6, which are mounted in mounting holes 2e of the working spindle 2 at the level of the recess 2b. The coil springs 6 push the clamping jaw 4 radially outwards into the receiving pocket 18a of the clamping sleeve 18, when the latter is axially shifted downwards (FIG. 7).

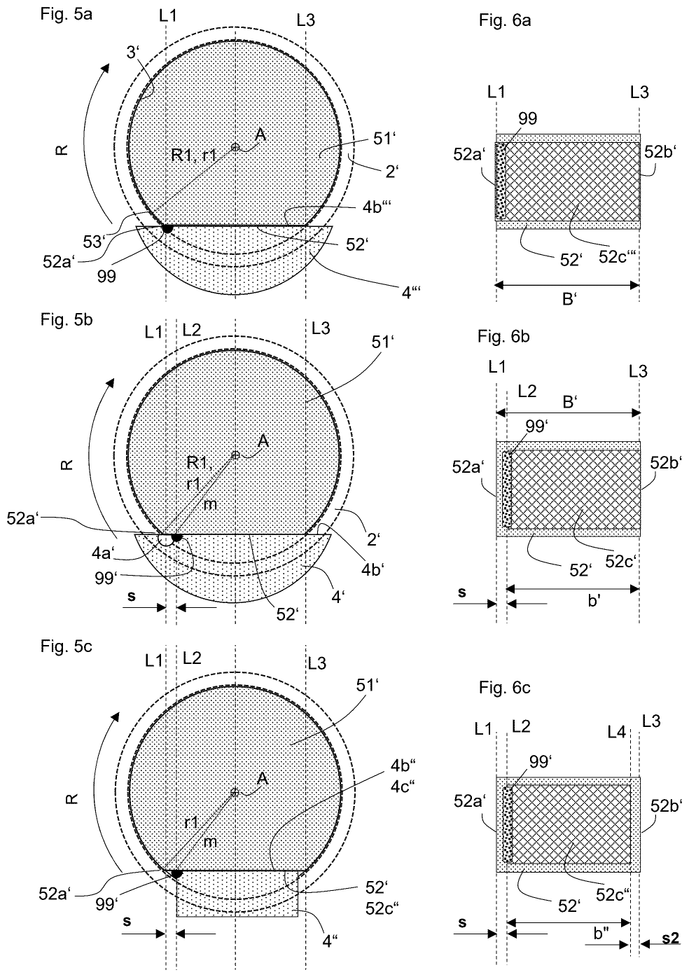

FIG. 5a schematically shows a cross-section of a toolholder not according to the invention along the x-y plane at the level of the clamping jaw 4″ in its second arrangement, with the tool shank 51′ in the assembly position. The black dot 99 symbolizes the occurrence of an accumulation of material 99 on the flat surface 52′ of the tool shank 51′, namely in the area of the transition of the flat surface 52′ into the cylindrical area of the tool shank 51′, i.e., on the flat surface side 52a′.

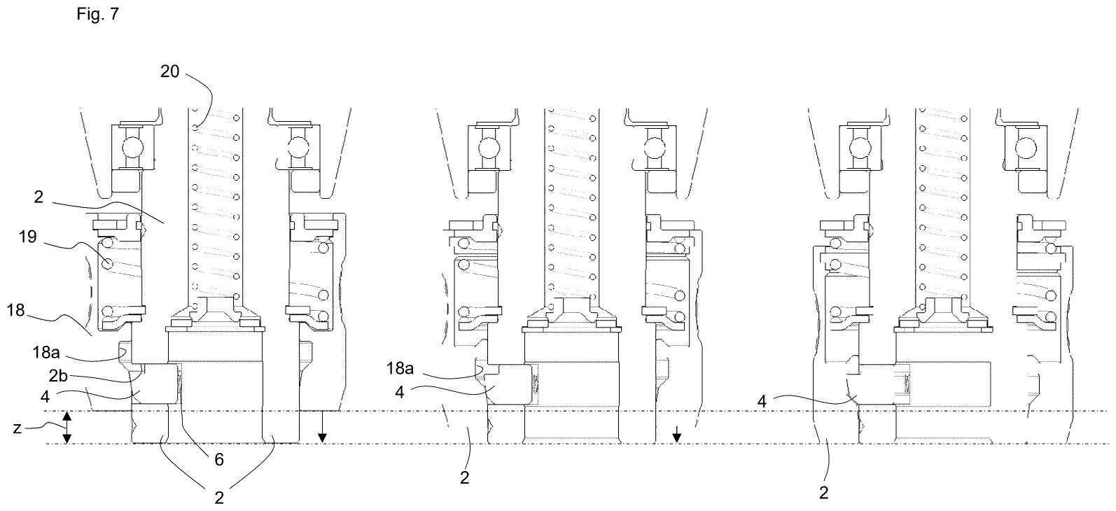

FIG. 6a shows the axial accumulation of material 99 on the flat surface 52′. The accumulation of material 99 is caused by an intensive load on the flat surface side 52a′ when the torque is transmitted, wherein only in the area of the transition from the flat surface 52′ into the cylindrical section 53′ is the flat surface side 52a′ loaded, and less the flat surface side 52b′ of the flat surface located opposite the flat surface side 52a′. The flat surface side 52a′ is the outside of the flat surface 52′ that lies in the direction of rotation when rotating about the axis A, while the flat surface side 52b′ is the outside of the flat surface 52′ located opposite the direction of rotation. The flat surface 52′, as well as the contact area 52c″, which is contacted here by the clamping surface 4b″, extends over the width B′, measured perpendicular to the axis A between the lines L1 and L3.

As shown schematically in FIG. 5a, the maximum outer diameter of the tool shank 51′ increases beyond the inner diameter (double outer radius R1) of the receiving space 3′ of the working spindle 2′ due to the accumulation of material 99 in the second arrangement of the clamping jaw. As a result, the accumulation of material 99 protruding into the recess 2b (shown in FIG. 3) of the working spindle blocks the removal of the tool shank 51′ from the assembly position, because the tool shank 51′ is arranged in radial directions in the receiving space 3′ without play.

The illustration in FIG. 5b is essentially the same as in FIG. 4b. As shown in FIG. 5b, an axial groove 4a′ is provided in the clamping surface 4b′ in a toolholder 1 according to the invention, which in the second arrangement of the clamping jaw 4′ is opposite the flat surface side 52a′. The resulting contact area 52c′ of the flat surface 52′, in which it is contacted by the clamping surface 4b′, is thus spaced by the distance s from the flat surface side 52a′. The distance s is measured along the flat surface 52′ perpendicular to the axis A, in this case between the lines L1 and L2.

As shown in FIG. 6b, an axial accumulation of material 99′ on the flat surface 52′ is also produced under load. However, the material accumulation 99′ is shifted inwards along the width B′ of the flat surface 52′ by the distance s, closer to the axis A, and away from the flat surface side 52a′. The displaced accumulation of material 99′ that arises at this point does not hinder the tool removal. As FIG. 6b shows, the plan surface 52′ is rectangular in shape and is bounded on one side by the first flat surface side 52a′ and on the other side by the second flat surface side 52b′ and has a width B′. The contact area 52c′, which lies within the flat surface 52′, has a width b′ reduced by the distance s′ compared to the width B′ of the flat surface 52′.

FIG. 5b shows that the material accumulation 99′ does not increase the maximum outer diameter of the tool shank 51′. The distance m of the material accumulation from the axis A plus the expansion of the material accumulation 99′ in the radial direction is always less than the receiving diameter R1, which corresponds essentially to the outer diameter r1 of the cylindrical outer surface of the tool shank.

FIG. 5c schematically shows, analogous to FIG. 5b, a cross-section of a toolholder 1 according to an example of the invention, in the second arrangement of the clamping jaw 4″, in which the clamping jaw 4″ has a different shape than the clamping jaw 4′ and the clamping jaw 4. The clamping jaw 4″ is shown here in a cuboid shape. However, it is essential that the contact surface 4c″ of the clamping jaw is essentially rectangular here. Instead of a recess or groove, the clamping surface 4b″ is dimensioned here and arranged in the second arrangement in such a way that the resulting contact surface 4c″ of the clamping jaw and the resulting contact area 52c″ of the flat surface is spaced from the flat surface side 52a′ by the distance s′, similar to the contact area 52c′ of FIG. 5b. The contour of the clamping surface bounding the clamping surface 4b″, which loads the flat surface 52′, is also removed by the distance s′ from the flat surface side 52a′. This also results in the effect, which is identical to the example of FIG. 5b, that the accumulation of material 99′ does not increase the maximum outer diameter of the tool shank 51′. The distance m of the material accumulation from the axis A plus the expansion of the material accumulation 99′ in the radial direction here is also always smaller than the receiving diameter R1, which essentially corresponds to the outer diameter r1 of the cylindrical outer surface of the tool shank.

FIG. 6c also shows that the resulting contact area 52c″ is spaced from the flat surface side 52a′ by a distance s′, similar to the contact area 52c′ of FIG. 6b, and that therefore the material accumulation 99″ is shifted away from the flat surface side 52a′. The width b″ of the contact surface 4c″ or the contact area 52c″ is smaller here than the width b′ in FIG. 6b. In this case, the clamping surface 4b″ does not touch either the first side of the flat surface 52a′ or the second side of the flat surface 52b′. The clamping surface 4b″ is arranged spaced from the flat surface side 52a′ by the distance s and from the flat surface side 52b′ by the distance s2 (distance between the lines L3 and L4).

FIG. 7 shows the three views of a cross-section of the toolholder 1 from FIG. 1b, in the x-z plane, each with different positions of the clamping sleeve 18 and the clamping jaw 4, when the clamping sleeve 18 is pushed from top to bottom by compressing the coil spring 19, so that the clamping jaw 4 is pushed from the second arrangement into the first arrangement by means of the coil springs 6, in which the user can insert the tool shank 51 into the receiving space 3 of the working spindle with almost no play. If the user lets the clamping sleeve 18 go, it is pushed back to the starting position by the return spring 19. In this resetting movement of the clamping sleeve, the inner surface of the clamping sleeve 18, which is adapted accordingly to the outer shape of the clamping jaw 4, pushes the clamping jaw 4 back into the second arrangement, so that the inserted tool shank 51 (not shown in FIG. 7) is in the assembly position.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A toolholder system for a tool that is rotatable about a rotation axis, the toolholder system comprising:
a toolholder for a tool rotatable about an axis of rotation; and
a tool with a tool shank,
a working spindle arranged on the toolholder, the working spindle extending along the axis of rotation and has an axially aligned, cylindrical receiving space comprising a receiving radius into which the tool shank that is cylindrical at least in sections and has an outer radius, is adapted to be inserted up to an assembly position by axially moving the tool shank, the tool shank having a flat surface that is radially shifted inwards from the outer radius, which has an axial flat surface side forming a transition of the flat surface to the cylindrical surface of the tool shank; and
at least one radially movable clamping jaw with a flat clamping surface,
wherein the toolholder is set up such that in a first arrangement of the clamping jaw, a minimum distance of the clamping surface of the axis of rotation is greater than or equal to an outer radius of the tool shank, and
wherein, in a second arrangement of the clamping jaw, the minimum distance of the clamping surface from the axis of rotation is smaller than the outer radius of the tool shank, and
wherein the clamping surface, in an assembly position, contacts a contact area of the flat surface and the contact area is spaced from the flat surface side.

2. The toolholder system according to claim 1, wherein the clamping jaw has at least one recess running axially in the clamping surface.

3. The toolholder system according to claim 2, wherein the recess is an axially running groove.

4. The toolholder system according to claim 3, wherein a width of the groove, measured in a direction substantially perpendicular to the axis A in a plane of the clamping surface, is between 1.0 mm and 10.0 mm or between 2.0 mm and 4.0 mm.

5. The toolholder system according to claim 3, wherein a depth of the groove, measured in a direction substantially perpendicular to the clamping surface, is between 0.1 mm and 2.0 mm or between 0.2 mm and 0.6 mm.

6. The toolholder system according to claim 1, wherein the recess extends through an entire height of the clamping surface.

7. The toolholder system according to claim 1, wherein a minimum distance of the contact surface from the flat surface side is between 0.5 mm and 5.0 mm.

8. The toolholder system according to claim 1, wherein the clamping surface has a contact surface, and the toolholder is set up for the contact surface in the second arrangement to contact the flat surface or its contact area, and wherein the contact surface is smaller than the flat surface.

9. The toolholder system according to claim 1, wherein the flat surface is rectangular in shape and has a second flat surface side opposite the flat surface side.

10. The toolholder system according to claim 9, wherein, in the second arrangement, the first flat surface side does not touch the clamping surface, and wherein the second flat surface side touches the clamping surface.

11. The toolholder system according to claim 1, wherein the contact area is smaller than the flat surface.

12. A stationary machine tool, a drilling machine, milling machine or core drilling machine, comprising a toolholder system according to claim 1.

13. A method for producing the toolholder system according to claim 1, the method comprising:
forming a shape of the clamping surface of the at least one clamping jaw such that the clamping surface in the assembly position contacts a contact area of the flat surface; and
distancing the contact area from its flat surface side.

14. The method according to claim 13, wherein the shape of the clamping surface of the at least one clamping jaw is formed by milling a recess into the clamping surface.

15. The toolholder system according to claim 1, wherein the toolholder is a Weldon toolholder for a milling tool or a core drill.
